(19) United States
(12) Patent Application Publication
(10) Pub. No.: US 2010/0125795 A1
(43) Pub. Date: May 20, 2010

(54) METHOD AND APPARATUS FOR CONCATENATING AUDIO/VIDEO CLIPS

(75) Inventors: Aline Yu, Palo Alto, CA (US); Karen Chao, San Mateo, CA (US); Daren Tsui, San Carlos, CA (US); Edwin Ho, Palo Alto, CA (US); King Sun Wai, Fremont, CA (US); Arthur Okada, Sunnyvale, CA (US)

Correspondence Address: DLA PIPER LLP (US ), 2000 UNIVERSITY AVENUE, EAST PALO ALTO, CA, 94303-2248, US

(73) Assignee: MSPOT, INC., Palo Alto, CA (US)

(21) Appl. No.: 12/649,010

(22) Filed: Dec. 29, 2009

Related U.S. Application Data
(63) Continuation-in-part of application No. 12/167,860, filed on Jul. 3, 2008.

(51) Int. Cl. G06F 3/01; G06F 17/00

(52) U.S. Cl. 715/723; 700/94

(57) ABSTRACT

A system for concatenating audio/video clips is disclosed.

### PRIORITY CLAIM/RELATED APPLICATION

This application claims priority under 35 USC 120 to and is a continuation-in-part of U.S. patent application Ser. No. 12/167,860 filed Jul. 3, 2008 which is incorporated herein by reference.

### FIELD

The disclosure relates generally to a method and apparatus for concatenating audio and/or video (“audio/video”) clips.

### BACKGROUND

The proliferation of cellular phones and other mobile devices with phone capabilities has led to a ring tone business where companies compete to provide ring tones. Currently, the ring tone market is as much as $1 billion dollars per year. There are several known techniques for getting a new ring tone and/or for creating a new ring tone. A ring tone sometimes is referred to as a ringer.

For a user to obtain a new ring tone, the user can often browse on a computer (not the mobile device) to a particular website from which the user can search for and select a ring tone. Once the user has selected the ring tone (often with the ability to listen to the ring tone before purchase), the user pays for the new ring tone and enters the phone number of the user's mobile device. Once the purchase is complete, the website sends a well known SMS message to the mobile device wherein the SMS message contains an embedded link to the selected ring tone on a wireless access protocol (WAP) site from which the ring tone may be downloaded. Thus, once the mobile device receives the SMS message, the user can click on the embedded link and then download the ring tone to the mobile device. One significant limitation with this approach is that it is often not possible to listen to the actual ring tone on the mobile device itself until after the ring tone is already purchased. In addition, the process of purchasing the new ring tone is a slow, multistep process which may cause a user to abandon the effort to download and then pay for the ringer.

For a user to create a new ring tone, the user may own a particular song/track and then use song editing equipment/software on a personal computer or the like to select a portion of the song/track and then generate the ring tone. There are also commercial services that provide a website that allows the user to create his/her own ring tone based on a track/song owned by the user or purchased by the user during the generation of the new ring tone. Once the ring tone is generated (either on the computer or at the website), the user must then download the new ring tone to the mobile device as before which complicates the process unnecessarily.

Mobile device users often choose their ring tone to reflect their musical taste or personality. It identifies the individual to such a degree that the user's colleagues eventually will know that it is the user's mobile device (as opposed to someone else's mobile device) that is ringing based solely on hearing the user's ring tone. Because a ring tone can become a personal identifier for the user, it would be desirable for the user to be able to use that ring tone as a personal identifier in contexts other than the ringing of the user's mobile device. A ring tone can more generally be considered to be an audio/video clip, where the audio/video clip can include audio content (as in a traditional ring tone), video content, or both.

The prior art also includes social networking websites available on the Internet, such as Facebook® (www.facebook.com) and myspace® (www.myspace.com).

It also would be desirable for a user to be able to concatenate different audio/video clips together to create a larger audio/video piece. For example, it would be useful for a user to be able to create an audio/video piece comprising audio/video clips that are chosen by the user in a particular order or that are chosen by the user or a computer and then placed in order automatically by the computer, such as by shuffling the clips. It also would be desirable for a user (or provider) to be able to share the audio/video piece with others, such as through a social networking website, email, web server, blog, or any using any other communication mechanism. It also would be desirable for a user (or provider) to be able to use all or part of the audio/video piece as a ringtone or to sell it commercially.

It also would be desirable to provide an interactive game using an audio/video piece. For example, a user or a computer could create an audio/video piece comprising audio/video clips and then use the audio/video piece in a computer-based game where other users will attempt to guess certain information about the audio/video clips, such as movie or song title, artist, actors and actresses, etc.

### BRIEF DESCRIPTION OF THE DRAWINGS

FIG. 1 is a diagram of a ringer generation system;

FIGS. 2 and 3 are diagrams of a method for ringer generation;

FIGS. 4A, 4B and 4C illustrate examples of a user interface for an implementation of the ringer generation system implemented on a mobile device;

FIG. 5 illustrates an example of a content system that may include the ringer generation system;

FIG. 6 illustrates an example of another content system that may include the ringer generation system;

FIG. 7 is a diagram of two users connected over a social network;

FIG. 8 illustrates an example of a user interface for an implementation of the social network activities relating to audio/video clips;

FIG. 9 is a diagram of a system that enables a user to automatically propagate his or her customized audio/video clip to a plurality of applications;

FIG. 10 is a diagram of a system that enables a computing device to obtain data concerning a user from another computing device;

FIG. 11 depicts exemplary audio/video clips and associated graphical depictions;

FIG. 12 depicts an exemplary graphical user interface for a system to concatenate clips together;

FIG. 13 depicts an exemplary concatenation of audio/video clips and its associated data structure;

FIG. 14 depicts exemplary audio/video clips and a concatenation of those clips;

FIG. 15 depicts exemplary audio/video clips and associated waveform images;

FIG. 16 depicts yet another embodiment of the system to concatenate clips together using waveform images;

FIG. 17 depicts waveforms images of clips being concatenated into a single waveform image;

FIG. 18 depicts the single waveform image with its associated audio/video piece;

FIG. 19 depicts an embodiment of an interactive game involving an audio/video piece;

FIG. 20 depicts another embodiment of an interactive game involving an audio/video piece;

FIG. 21 depicts another embodiment of an interactive game involving an audio/video piece; and

FIG. 22 depicts another embodiment of an interactive game involving an audio/video piece.

### DETAILED DESCRIPTION OF ONE OR MORE EMBODIMENTS

One embodiment is particularly suitable for generating an audio ringer for a mobile phone on the mobile phone itself, and it is in that context that a system and method are described for illustration purposes. However, the system and method may also be used to generate a ring tone for other mobile computing devices with phone capabilities and may be used to generate different ring tones, such as video ring tones or audiovisual ring tones.

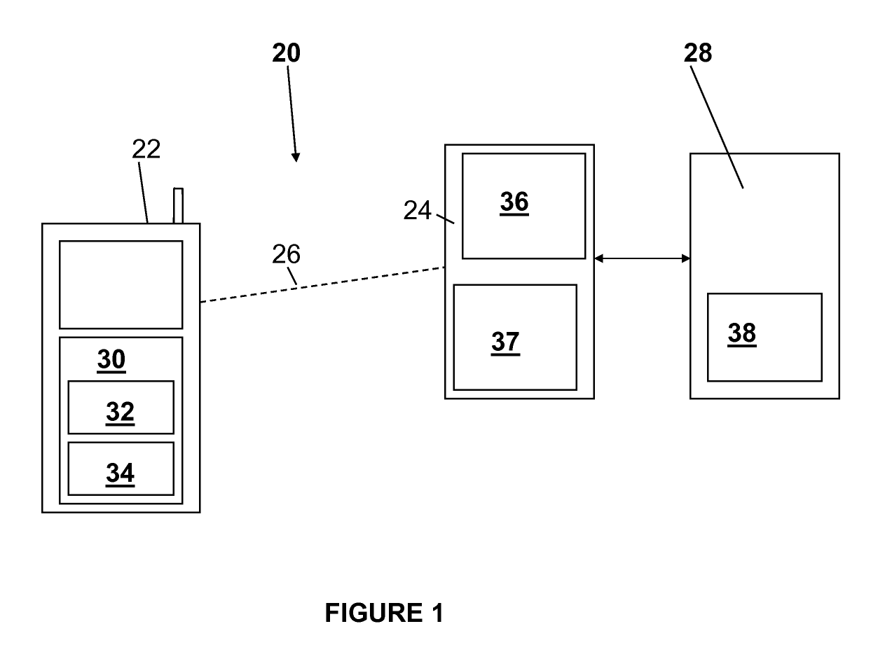

FIG. 1 is a diagram of a ringer generation system 20. The system may include a mobile computing device 22, such as mobile phone in the illustrated example, a generator unit 24 that can communicate and exchange data with the mobile computing device over a network 26, such as a cellular phone network in the illustrated example, and the generator unit 24 is in turn capable of communicating with and exchanging data with a computing device 28. The mobile computing device may be a processing unit based device with phone capabilities and the typical components of a device, such as a PDA, mobile phone, wireless email device (such as the Blackberry), or other handheld device that has wireless connectivity to be able to communicate with the network 26. The computing device 28 may be a processing unit based device, such as a server computer, personal computer and the like.

In the ringer generation system, the mobile computing device 22 may further include a memory 30 that may further contain a generator module 32 and a store 34 wherein the generator module 32, may be implemented, for example, with a plurality of lines of computer code that are executed by the processing unit of the mobile computing device, and may be used to generate a new ringer on the mobile computing device. In one embodiment, the generator module may be a piece of code comprising a plurality of lines of JAVA language computer code (a JAVA language application) that are executed by a Java engine that is already stored on the mobile computing device. The store 34 may be, for example, a software based database that allows the user of the mobile computing device to store one or more pieces of content that may be played by the mobile computing device such as music, video, etc. as well as the ringers that are generated by the generator module.

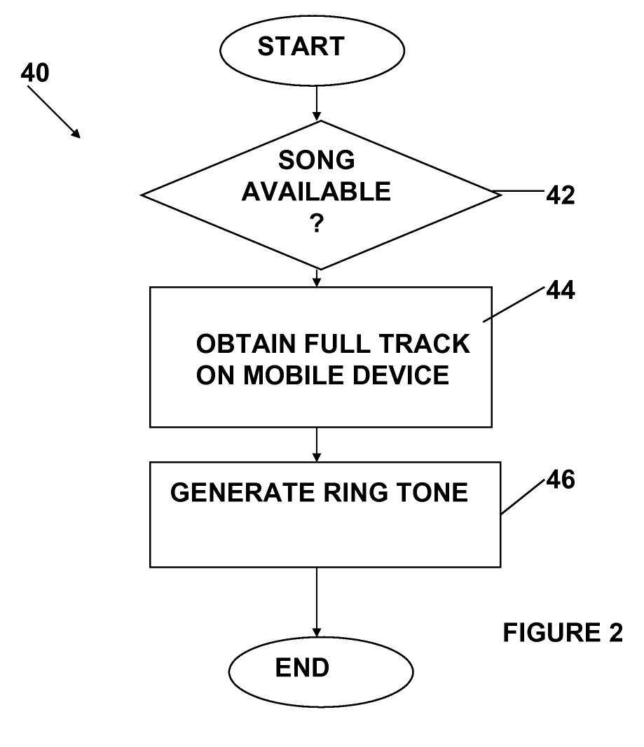

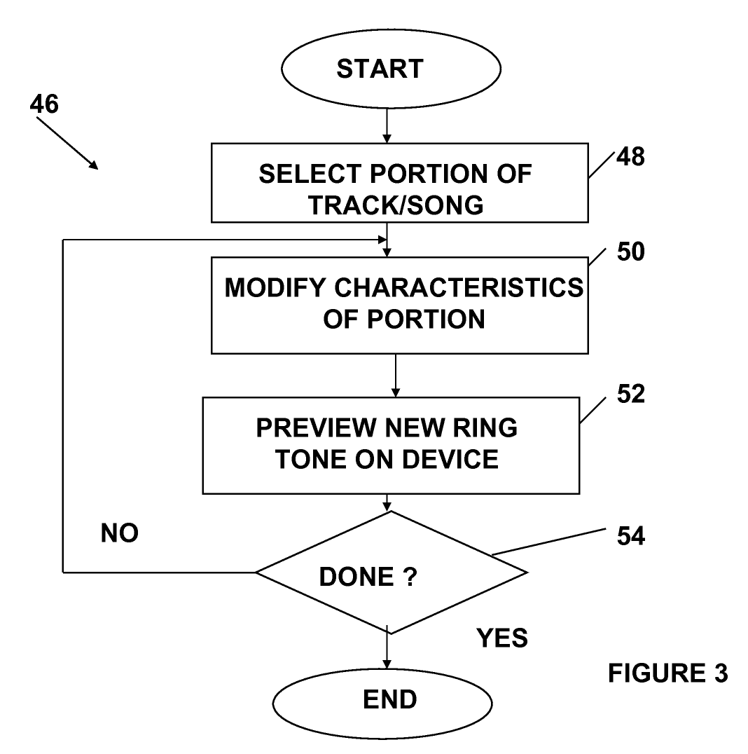

The generator unit 24 may be, for example, a server computer, that may further comprise a generator 36 that performs some of the functions and operations of the ringer generation method described in FIGS. 2-3 as described below in more detail. For example, the generator 36 may determine if a full track of the ringer content is available either in a content store 37 in the generator unit 24 and/or in a content store 38 associated with the computing device 28. The generator unit may also include the ability to communicate with the mobile computing device and deliver data to the mobile computing device as described in more detail below. Using the above system, the user of the mobile computing device optionally is able to generate a new ringer directly on the mobile computing device, adjust the characteristics of the new ringer, preview the ringer before purchase, and then download the new ringer.

In one illustrative embodiment, the generator module allows users to make personalized ringers for their mobile computing devices directly from their mobile computing devices. The generator module allows the user to use their own music track (in the content store 38 in the computing device 28) or one from a catalog of songs (in the generator unit store 37) to generate the ringer. The user may be given a visual representation of the track and the user then chooses the start and end points of the ringer. The user then receives a ringer that they can use throughout their mobile computing device.

FIGS. 2 and 3 are diagrams of a method 40 for ringer generation. The method may be carried out by the generator module 32 and the generator unit 24 shown in FIG. 1. In the method, the user of the mobile computing device may request to make a new ringer based on a particular piece of content, such as a particular track of music. This request is communicated to the generator unit that determines if the particular track is available (42) either in the store of the generator unit and/or in the computing device store. Since the upload speed of the mobile computing device is typically slow so that it is quite time consuming to upload an entire song to the generator unit (to determine if the track is available) for processing, the mobile computing device may instead generate a digital signature for the track. The digital signature may be used by the generator unit to search the content store to determine if there is a match for the requested track in the content store in either the generator unit or the computing device. This allows the service to ensure that the end user had the digital rights (DRM) or a legitimate copy of the track/song so that the system and method can enable the ringer editing capability. This service is not possible under current rights agreements without a copy of the full track. In one example, the user may browse a user interface to select a particular track/song and then locate that song/track.

If the particular track is not available, the method is completed. On the other hand, if the track is available, then the full track is obtained by the mobile computing device (44) wherein the full track is downloaded from the generator unit since the full track on the mobile computing device (if available) will be of lower resolution and poorer quality. Once the full track is available at the mobile computing device, the generator module in the mobile computing device may be used to generate a ringer (46).

During the ringer generation, the generator module may allow the user to select a portion of the track (48) and then modify certain characteristics of the track (50). The generator module may also preview the ringer (52) on the mobile computing device. If the preview is not acceptable (54) (which is a preview of the actual ringer), the method loops back to any prior process so that the user can revise and redo the ringer. If the ringer is acceptable, then the method is completed and the ringer is purchased by the user and the user can use the ringer. In addition, a user may move between any process in FIG. 3 and any other process in FIG. 3.

The system and method may be used to generate an audio ringer (described above). It may also be used for video ringers, a ringer linked with an image or an audiovisual ringer. The song/track used to generate the ringer may be the songs/tracks already stored in the mobile computing device, a catalog of songs/tracks maintained by the generator system (so the user can purchase the full track and then create the ringer) or songs/tracks located on the computing device owned by the user.

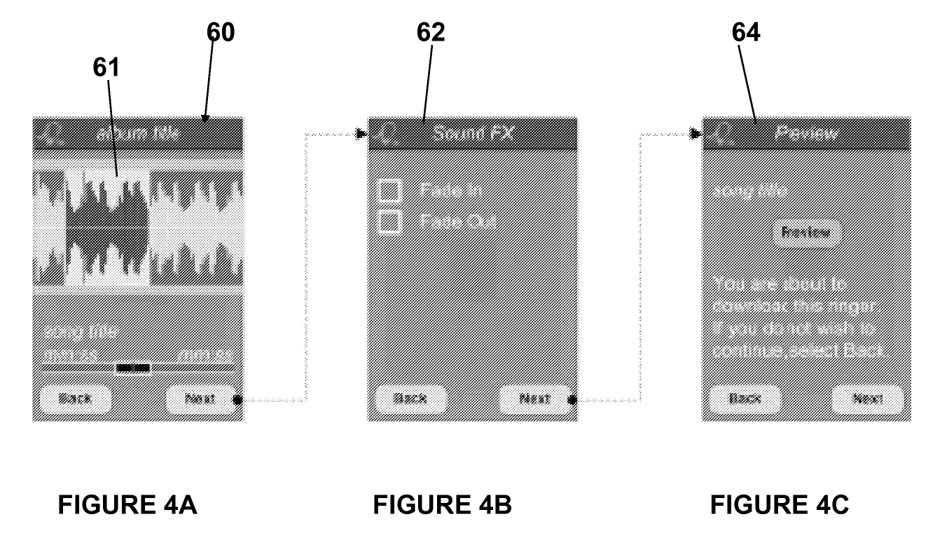

FIGS. 4A, 4B and 4C illustrate examples of a user interface for an implementation of the ringer generation system implemented on a mobile device. Most mobile computing devices have an input device, such as a four way keypad that may be used as the primary interface device for the ringer generation method that allow the user to create and/or modify a ringer. The input device permits the user to edit, zoom, playback, and download the track and/or ringer. Optionally, when doing zooming/editing of the track profile, the digital data representing the track is downloaded to the mobile computing device from the generator unit (rather than having the processing unit of the mobile computing device generate the visual representation of the track) so that the zooming and/or editing can be done without using the limited CPU of the handset.

As shown in FIG. 4A, a user interface 60 allows the user, using the 4 way input device to select the portion of the track for use as the ringer. A window 61 is superimposed over the profile of the track that shows the portion of the track currently selected by the user. The user interface may also magnify the left edge of the track profile when the user adjusts the starting point of the ringer as shown by the window 61. The user interface may also magnify the right edge of the track profile when the user adjusts the length of the ringer as shown by the window 61 and then play a few seconds at the end of the ringer so that user can determine if the end is the appropriate location.

FIG. 4B shows a user interface 62 that allows the user to adjust certain other characteristics of the ringer such as a fade in or a fade out or various other characteristics of the ringer. FIG. 4C shows a user interface 64 that allows the user to preview the actual ringer on the mobile computing device before purchasing the ringer. In typical systems using WAP pages, it is not possible to permit a preview since the download from the WAP page would allow the user to preview and then keep the ringer without payment. In the ringer generator system, the ringer is streamed and is not permanently stored (downloaded into the memory and used by the JAVA code) so that it can be previewed without losing the ability to charge for the ringer. As shown in the series of user interfaces, the generator system permits the ringer generation and download to occur from a single series of user interfaces so that it is easier for the user to generate, preview and then download the ringer.

In an alternative embodiment, after viewing the representation of the fulltrack and selecting the start and end points of the track to be played when the phone rings as shown in FIG. 4A, the user can store the location of the start and end points for the ringer on the mobile computing device. Then, the mobile device can be modified to use the start and endpoints to playback only the portion of the fulltrack specified without the need to make another copy of the full track on the mobile computing device. In this alternative embodiment, if the user already owns the full track for the song being used to make the ringer and the full track is stored on the mobile computing device, the ringer generator does not need to make another copy of the full track of the song in order to playback the ringer. In this alternative embodiment, the ringer is played by playing the portion of the full track (identified by the stored start and end points of the ringer) whether the song uses DRM or not. Thus, the user does not need to pay for the mechanical and music rights to another copy of the full track in order to specify a new ringer.

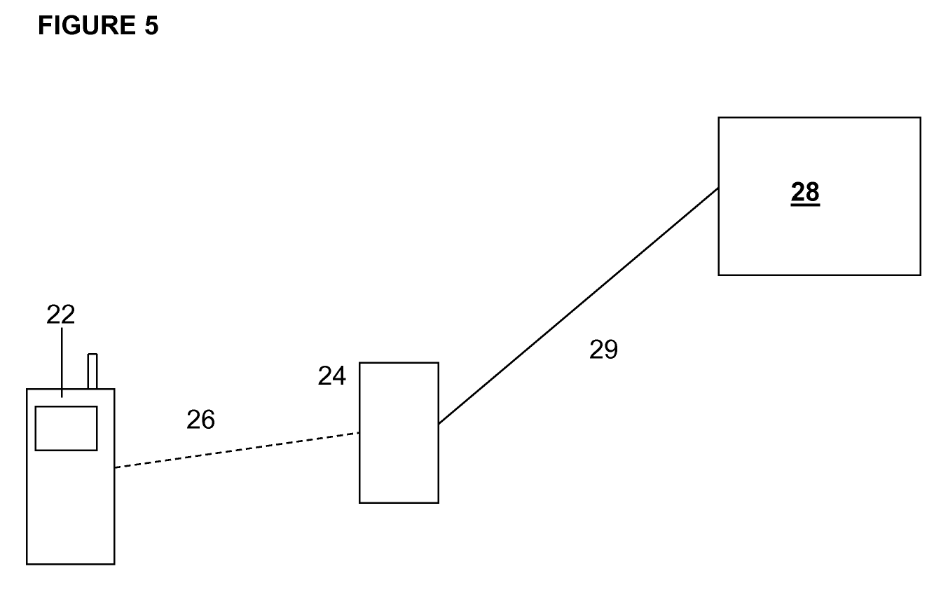

FIG. 5 illustrates an example of a content system that may include the ringer generation system. As in the prior art, a user stores digital content (such as music, video, etc.) on computer 28. However, in this embodiment, the user downloads the digital data from computer 28 to mobile computing device 22 in a wireless fashion over a wireless communication path. Mobile computing device 22 may be a PDA, mobile phone, wireless email device (such as the Blackberry), or other handheld device that has wireless connectivity to be able to communicate with the computer 28 and download digital content from the computer 28. Computer 28 communicates with a device 24, such as a server computer, over network 29. Network 29 can be any type of network, such as the Internet, and can be hardwired, wireless, or some combination of the two. Computer 28 runs a software application that allows a user to catalog and organize the digital content of the user. The device 24 can be accessible over the Internet (such as through a URL address). The device 24 is shown in FIG. 5 as a single device. However, it is to be understood that the device 24 can instead comprise multiple devices, such as multiple servers.

Mobile computing device 22 connects to device 24 over a wireless network 26. Wireless network 26 can be a cellular telephone network, a WiFi network (such as an 802.11 network), a wireless data network (such as EV-DO or EDGE), or any other wireless network. It is to be understood that wireless network 26 need not connect directly to server device 24, but instead can connect through an indirect means such as by the Internet or through another network. The ringer generator system shown in FIG. 1 can be integrated with this content system.

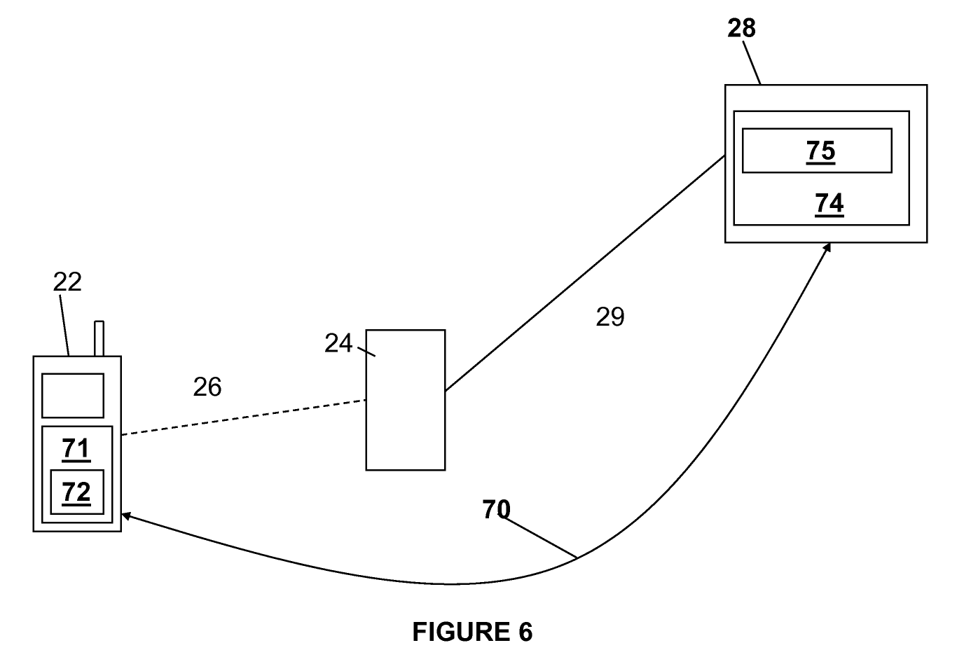

FIG. 6 illustrates an example of another content system that may include the ringer generation system wherein the content system allows a mobile computing device 22 to share content among a plurality of computing devices wherein the mobile handset has the content store 71 and playlists 72. As shown, the system permits the mobile computing device 22 to synchronize its content with a plurality of computing devices 28₁, 28₂, . . . , 28n and each computing device maintains a content store 74 and at least one playlist 75 for the content on the mobile handset. For example, in a family in which the different family members each have their own computing device, the mobile handset of a particular family member can be synchronized to the multiple computing devices so that the content purchased by each member of the family can be shared. Similarly, the system permits multiple mobile handsets to synchronize their content with a single computing device (such as might be the case of a family) or multiple mobile handsets can synchronize their content with multiple computing devices. Thus, the system permits the computing devices to effectively share content between the computing devices.

In another embodiment, a user can share a customized audio/video clip (such as a ring tone) with other users over a social networking website such as facebook® or myspace®. Social networking websites have become popular in recent years and allow users to register with the website and form social networks of friends and colleagues. Users in a social network can then interact online by exchanging messages, photos, and other forms of information. Each user typically is given a personal page within the social networking website where the user can post information about himself or herself, such as the names and photos of the user's friends who are members of the social networking website, a description of the user's background, the user's opinions on a variety of issues and media content, and other information.

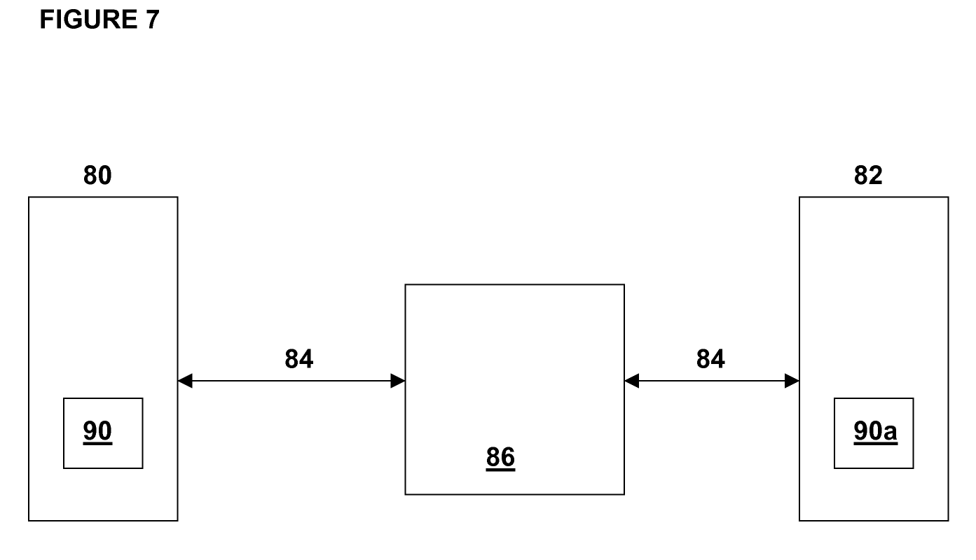

With reference now to FIG. 7, User A operates computing device 80. User A creates an audio/video clip 90 on computing device 80 using the methods illustrated in FIGS. 2-4 or by using a different method, such as the prior art method of creating ring tones on computers by accessing a website over a desktop or notebook computer. Audio/video clip 90 can be an MP3 file, other MPEG file, JPEG file, or other type of file that can store audio and/or video data. User B operates computing device 82. Computing devices 80 and 82 can be mobile devices, notebooks, desktops, servers, or other computing devices. Users A and B connect to server 86 over a network 84 such as the Internet. Network 84 can comprise a plurality of separate networks using a variety of communication mediums, such as hardwired connections, wireless connections, etc. In this example, server 86 operates a website, such as social networking website or another website that permits users to post or communicate content to others or to exchange content.

User A then shares audio/video clip 90 with User B through server 86. User A can do this, for example, by posting audio/video clip 90 on his personal page on a social networking website hosted on server 86, such that User B and other users can hear/see the clip when they visit User A's personal page, either automatically, by clicking on an icon (such as a play button), or by some other method. User A also can send audio/video clip 90 to User B through the communication mechanism of the social networking website, such as by sending a message, email, “gift,” “poke,” or other methods. facebook® currently offers the ability for one user to send another user a “gift,” such as a graphical icon of a flower or box of candy, or to “poke” (using a facebook® application called “superpoke” offered by slide.com or other applications) by sending a short graphical animation, such as a depiction of the sender throwing a sheep at the recipient. Under this embodiment, User A would be enabled to transmit his or her audio/video clip 90 to User B, such as by sending a “gift” or “poking” User B. User B can then store audio/video clip 90 on his or her computing device as audio/video clip 90a. In this manner, User A is able to share his or her audio/video clip 90 with User B through a website operated by server 86, such as a social networking website or another website that enables users to exchange content. Audio/video clip 90a can be identical to audio/video clip 90, or it can be a modified version of it (such as a shorter version, a compressed version, a lower fidelity or lower resolution version, etc.).

If computing device 82 is a mobile device (such as a cellular handset), there are a number of different mechanisms by which it can receive audio/video clip 90 from computing device 80. For example, server 86 can send a text message using SMS to computing device 82 (e.g., “You have received an audio clip from User A. Click this link to access.”). User B can then access audio/video clip 90 by clicking the link, which typically would launch a website browser that would enable User B to access audio/video clip 90. In the alternative, server 86 can send a message using MMS to computing device 82 (e.g., “You have received an audio clip from User A. Click here to listen.”) MMS enables the sender to embed the actual audio or video content into the MMS message, so that the message received by computing device 82 actually contains the audio/video clip 90 within it, such that computing device 82 would not need to obtain the clip from elsewhere and could begin playing the clip immediately upon being instructed by the user to do so. In the alternative, server 86 can simply send information to User B through normal website mechanisms (such as by sending a message to User B's account within a social networking website), and User B can access audio/video clip 90 on the website using a browser on computing device 82.

If computing device 82 is a traditional desktop or notebook computer, then it can receive audio/video clip 90 via a website, email system, instant messaging system, or other communication mechanism.

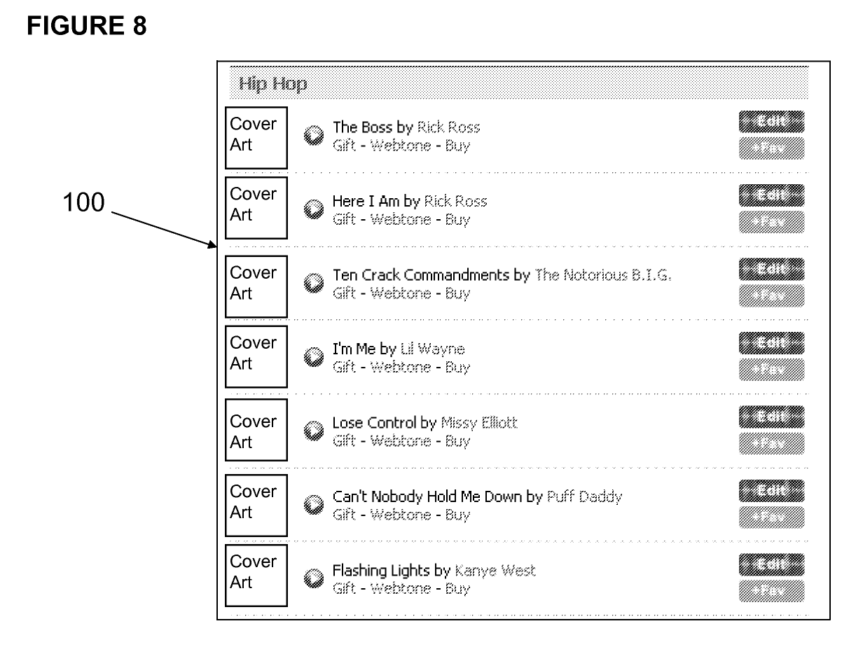

Optionally, User B is provided with the ability to purchase audio/video clip 90 to use as a ring tone on his or her own mobile device, if User A has not already purchased that right for User B. This can be facilitated by a button, link, or other mechanism on User A's personal page on the social networking website that allows User B and other users to purchase audio/video clip 90 to use as a ring tone on his or her own mobile device, or it can be facilitated by a button, link, or other mechanism in the message, email, “gift” or other communication method by which User A sent the audio/video clip to User B. FIG. 8 shows an exemplary user interface 100 that provides a user with the options discussed above, namely, “Gift,” “Buy,” and “Edit.” In another aspect of the embodiment, a user can be provided the option of buying the entire piece of content (e.g., an entire song) from which the audio/video clip was taken.

In another embodiment, User A creates the audio/video clip 90 from an application within the social network website. The application can have a similar user interface as that shown in FIGS. 4A-4C. This application can be created using HTML or other code that is embedded within the social networking website.

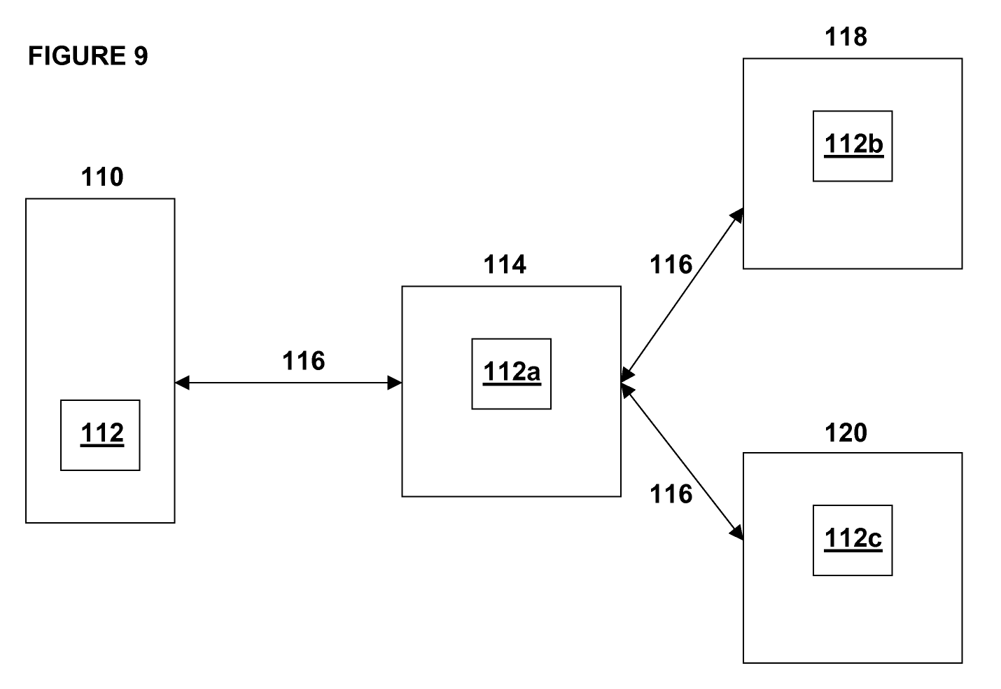

In another embodiment, an audio/video clip created by a user is disseminated to a plurality of destinations that in turn will use the audio/video clip in an application or manner associated with a user. With respect to FIG. 9, User A creates audio/video clip 112 on computing device 110, using one of the mechanisms described previously. Computing device 110 stores audio/video clip 112 in its memory or storage device. User A's computing device 110 connects to server 114 over network 116. Optionally, User A can create audio/video clip 112 on server 114 instead of on computing device 110, or User A can do so with computing device 110 in conjunction with computing device 110. Server 114 stores audio/video clip 112 or a modified version in its memory or storage device as audio/video clip 112a. Server 114 in turn connects to server 118 and server 120 over network 116. Network 116 can be the Internet or any combination of networks.

In this embodiment, when User A creates audio/video clip 112, computing device 110 provides that clip to server 114, which stores it or a modified version as audio/video clip 112a. Server 114 then automatically provides that content to servers 118 and 120, which are servers that store content or websites previously accessed or designated by User A. For example, server 114 might operate a website that facilitates the creation of audio/video clips for users, and servers 118 and 120 might operate a social networking website, email service, instant message service, electronic bulletin board, or other service. Servers 118 and 120 then receive audio/video clip 112a or a modified version from server 114 and then each stores it in its memory or storage device as audio video clips 112b and 112c, respectively. Audio/video clips 112a, 112b, and 112c can be identical to audio/video clip 112, or any or all of them can be modified versions of audio/video clip 112 (such as a shorter version, a compressed version, a lower fidelity or lower resolution version, etc.).

Server 114 performs the step of automatically providing audio/video clip 112a as a result of a software application that is running on server 114 that has previously been configured by or on behalf of User A to automatically provide audio/video clips to servers 118 and 120. For example, User A can instruct server 114 through the software application to automatically send the audio/video clip to servers 118 and 120 whenever User A sends a modified audio/video clip to server 114. Computing device 110 can provide the audio/video clip 112 to server 114 using an API or other interface mechanism. Similarly, server 114 can provide the audio/video clip 112a to servers 118 and 120 using an API or other interface mechanism.

Using this embodiment, User A is able to have his or her personal audio/video clip automatically updated on servers 118 and 120. This audio/video clip can serve as a personal identifier for User A. For example, if server 118 operates an instant messaging service (such as one currently offered by Yahoo!®, available at www.yahoo.com), then when User A sends an instant message to User B, User B can be prompted with a text message indicating that User A is sending an instant message to User B and/or User B can be prompted with audio/video clip 112a.

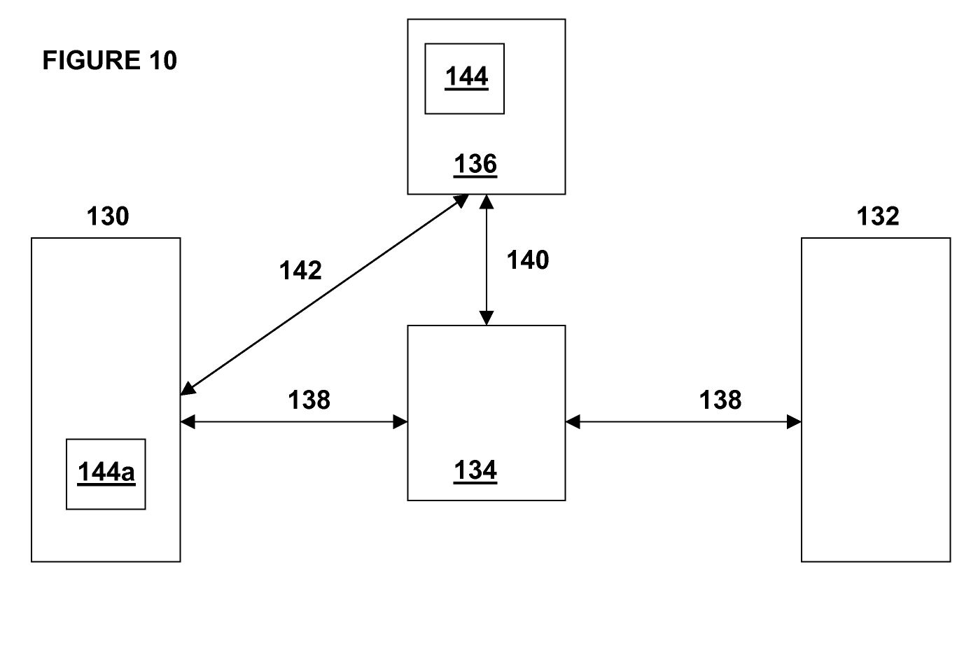

With reference now to FIG. 10, User A operates computing device 130. User B operates computing device 132. Computing device 136 is a device that stores data that is related to User B. For example, computing device 136 can be a server that hosts a social networking website on which User B creates a user page containing data related to User B, such as a customized audio/video clip, a photo of User B, information regarding User B (such as his favorite movie, favorite book, favorite greeting, favorite quote, etc.) User B inputs data 144 into computing device 136. For example, User B can create an audio/video clip on computing device 132 using the methods illustrated in FIGS. 2-4 or by using a different method, such as the prior art method of creating ring tones on computers by accessing a website over a desktop or notebook computer. Computing devices 130, 132, and 136 can be mobile devices, notebooks, desktops, servers, or other computing devices. Computing devices 130 and 132 are enabled to communicate with one another by device 134. Device 134 can be a computing device or any device that enables network, voice, cellular, or data communication. Computing devices 130 and 132 connect to device 134 over a network or link 138. Device 134 can communicate with computing device 136 over network or link 140. Computing device 130 can communicate with computing device 136 over network or link 142. Network or link 138, 140, and 142 each can comprise a plurality of separate networks or links using a variety of communication mediums, such as hardwired connections, wireless connections, etc. Network or link 138, 140, and 142 each can be part of the same network (such as the Internet), or they can be separate networks or links, or they can overlap.

In the situation where computing devices 130 and 132 are mobile handsets, User B uses computing device 132 to call User A on computing device 130. Device 134 recognizes computing device 132 as the initiating device of the call (by using the prior art “caller ID” feature” or other method). Device 134 then accesses computing device 136 and searches for any data 144 previously stored there by User B and/or stored there in a manner that associates the data with computing device 132. If device 134 finds such data, it downloads it from computing device 136 and sends all or part of it to computing device 130. Computing device 130 stores data 144 as data 144a (which is either identical to data 144 or is a revised version of data 144 or a portion thereof) in its memory or storage device. Computing device 130 then alerts User A that User B and/or computing device 132 is calling by playing and/or displaying data 144a. For example, if data 144a includes a ringtone, computing device 130 can play the ringtone. If data 144a includes a photo, computing device 130 can display the photo.

In the alternative, device 134 can send identifying information (such as caller ID information) to computing device 130, and computing device 130 can communicate directly with computing device 136 to search for and obtain data 144. Once it obtains data 144, computing device 130 stores it as data 144a, and it can operate in the same manner described previously.

The embodiment shown in FIG. 10 and described above has the benefit of enabling User A to hear a ringtone customized by User B and to see data that is specific to User B, such as his or her photo. User B can modify the ringtone or data without involving User A or computing device 130, yet User A will still be able to hear/see the modified data when User B calls User A. This can be an interesting way for people to share clips of their favorite music with one another, or to share new photos. For example, if User B is traveling around the world, each time User B calls User A, he can send a new photo that he previously uploaded to computing device 136 to show User A a new aspect of User B's travels.

Concatenation of Audio/Video Clips

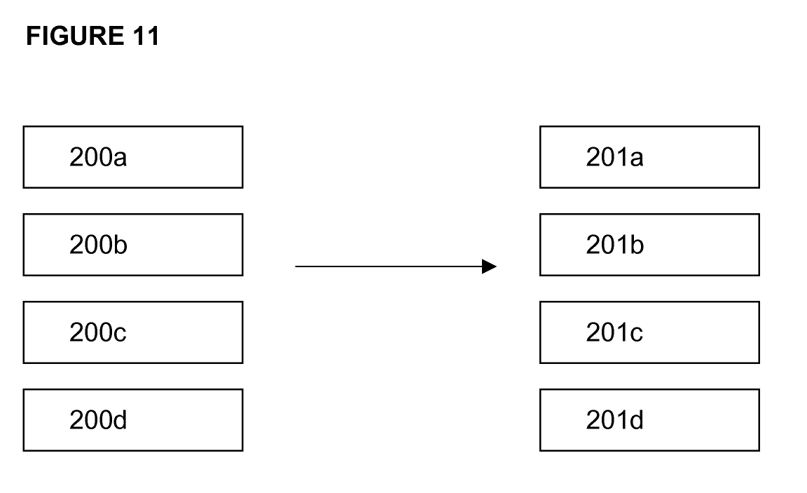

FIG. 11 depicts exemplary audio/video clips 200a, 200b, 200c, and 200d, which can be created using the embodiments described above or by other mechanisms. Audio/video clip 200a can be depicted graphically as graphical depiction 201a. For example, graphical depiction 201a might be a graphical box containing a title for audio/video clip 200a input by a user. Similarly, audio/video clips 200b, 200c, and 200d can be depicted graphically as graphical depictions 201b, 201c, and 201d, respectively.

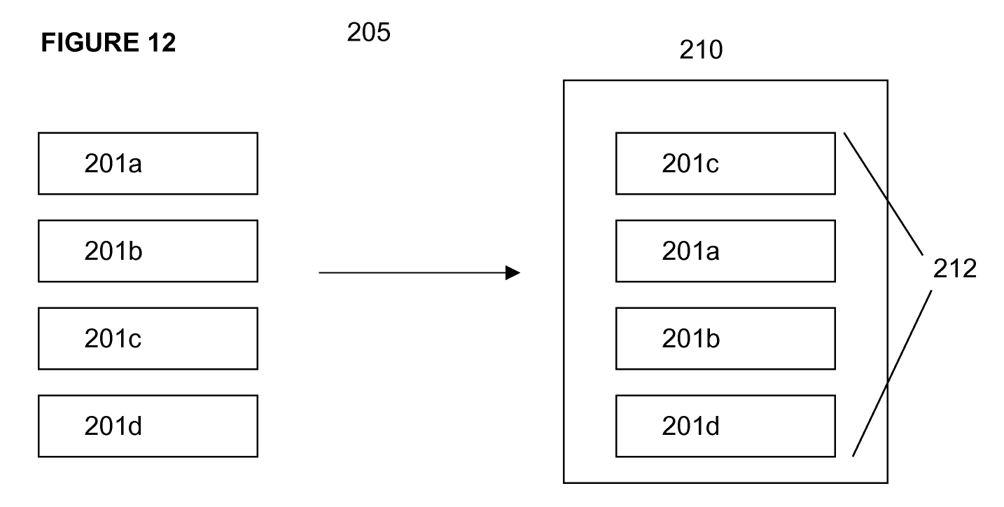

FIG. 12 depicts exemplary graphical user interface 205. Graphical user interface 205 is generated on a monitor, screen, on the mobile computing device 22 shown in FIG. 1 above or other visual device. Graphical user interface 205 displays graphical depictions 201a, 201b, 201c, and 201d. The user is then given the ability to select audio/video clips to use in a larger audio/video piece 212 by selecting graphical depictions 201a, 201b, 201c, and 201d and then placing them in the preferred order, for instance, by dragging and dropping them into graphical box 210. In this example, the user has dragged graphical depictions 201a, 201b, 201c, and 201d into box 210 such that graphical depiction 201c is the first clip in graphical depiction 212, graphical depiction 201a is the second clip, graphical depiction 201b is the third clip, and graphical depiction 201d is the fourth clip. This, of course, is merely exemplary. The user could select from any number of audio/video clips and place them in the order of his or her choosing. These actions can occur on a computing device, such as mobile computing device 22, or another computing device such as computing device 28.

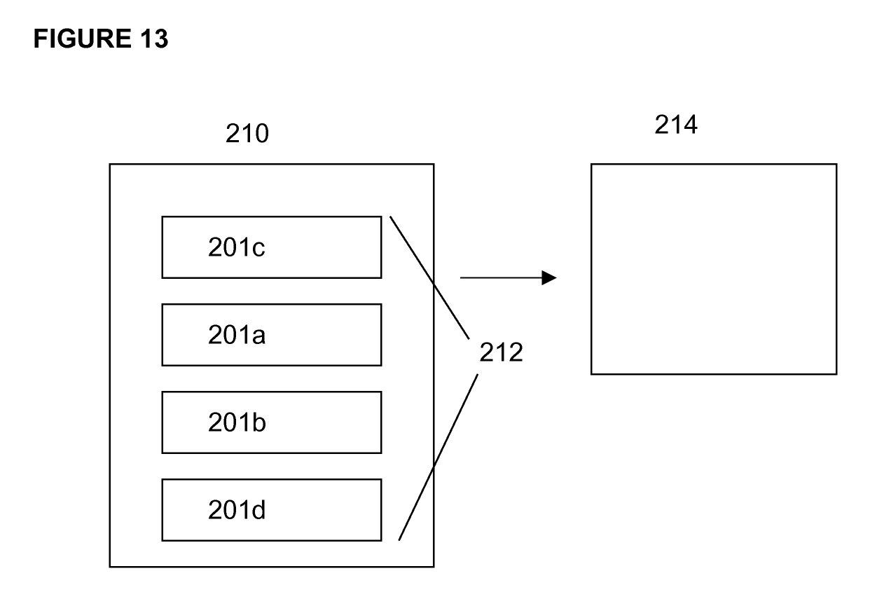

With reference to FIG. 13, box 210 and its contents have an associated data structure 214. In this embodiment, data structure 214 can include data associated with box 210 and its contents, such as: identifiers for graphical depictions 201c, 201a, 201b, and 201d; identifiers for underlying audio/video clips 201c, 201a, 201b, and 201d; data indicating the selected order of the graphical depictions and underlying audio/video clips; the actual content of audio/video clips 201c, 201a, 201b, and 201d (such as the audio/video clips themselves, for example, MP3 files), any descriptive data created for box 210 and its contents (such as a title for graphical depiction 212, e.g. “My Favorite Mix”), and associated metadata (e.g., file name and path name, date modified, date created, etc.). Data structure 214 can be stored in memory, in a non-volatile storage device, or using other storage mechanisms. Data structure 214 can be stored in mobile computing device 22, on computing device 28, or elsewhere.

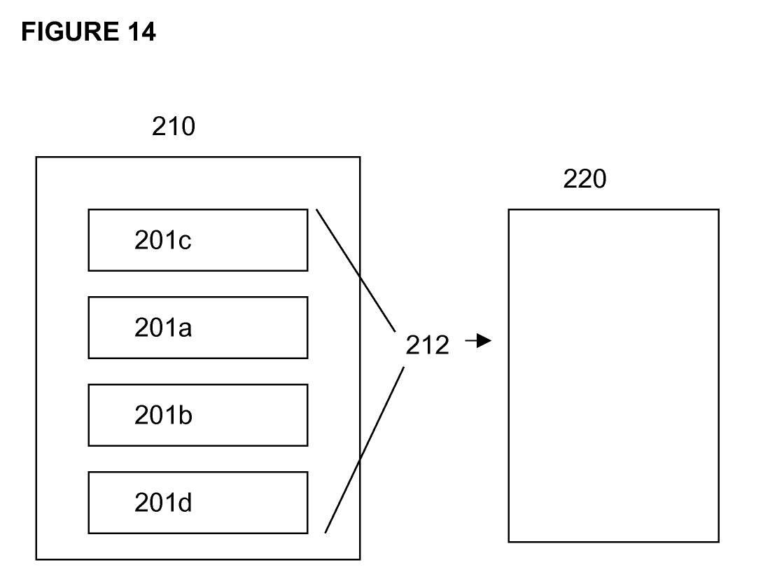

With reference to FIG. 14, the underlying audio/video content associated with graphical depiction 214 optionally can be converted into audio/video piece 220. Audio/video piece 220 optionally can be a single MPEG or JPEG file or audio compressed file or a set of associated files. Audio/video piece 220 will include the content from the underlying audio/video clips 201c, 201a, 201b, and 201d. For example, if those underlying audio/video clips were clips of music, then audio/video piece 220 will include each of those clips of music, which a user could listen to. Audio/video piece 220 optionally can include “transitions” between each underlying audio/video clips 201c, 201a, 201b, and 201d. For instance, in the audio realm, the transitions might include fading of one audio clip before a second audio clip begins, or the placement of “filler” audio data (such as a drum beat). In the video realm, the transitions might include fading of one video clip before a second audio clip begins, or a gradual morphing of one video clip into another. These actions can occur on a computing device, such as mobile computing device 22, or another computing device such as computing device 28. The transitions can be selected by the user or automatically by a computing device. The transitions also can comprise the insertion of other audio or video content, such as advertising, a photo, other audio or video clips, or a “laugh track” that is commonly used in TV sitcoms or advertising. In the realm of advertising, a computing device optionally can select advertising content based on the underlying audio/video content of audio/video clips 201a, 201b, 201c, and 201d. One example of such targeted advertising is described in commonly-owned and co-pending U.S. patent application Ser. No. 11/490,798, filed on Jul. 20, 2006, and titled “Method and Apparatus for Providing Search Capability and Targeted Advertising for Audio, Image, and Video Content Over the Internet,” which is incorporated herein by reference. For example, if one audio clip contained the word “car” in it, then a computing device could insert an advertisement on cars as part of the transition between clips.

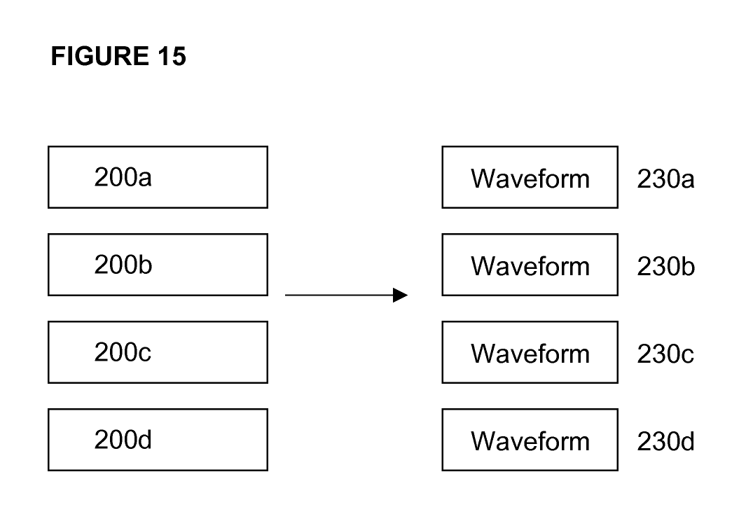

FIG. 15 depicts another embodiment. Exemplary audio/video clips 200a, 200b, 200c, and 200d can be depicted graphically as waveform images 230a, 230b, 230c, and 230d, respectively. These waveform images are graphical images that correspond to the actual audio waveforms of the audio/video clips. (An example of a waveform image is shown in FIG. 4A.). These actions can occur on a computing device, such as mobile computing device 22, or another computing device such as computing device 28. In another embodiment, exemplary audio/video clips 200a, 200b, 200c, and 200d can be depicted using other graphical mechanisms, such as copies of album art if the clips are portions of music tracks.

In another embodiment, a user could instruct a computing device to perform a preview of what will become audio/video piece 220 before the underlying audio/video clips are concatenated to create the audio/video piece 220. For example, the computing device could play each individual audio/video clip in sequence without actually concatenating them.

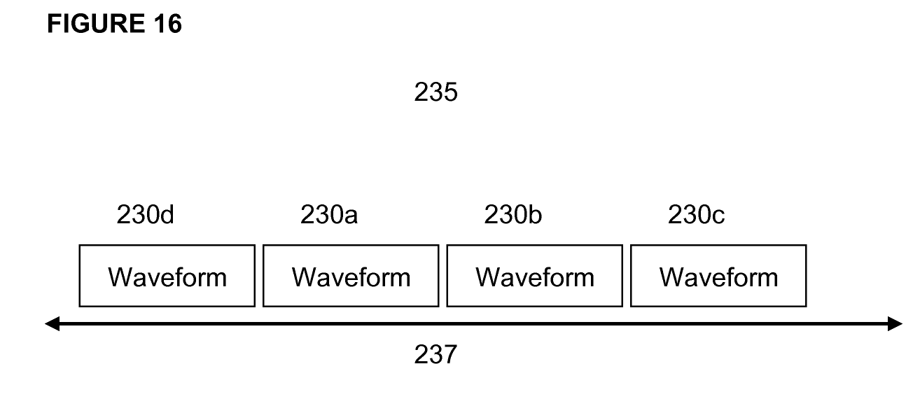

FIG. 16 depicts another embodiment. Graphical user interface 235 is generated on a monitor, screen, or other visual device. Graphical user interface 235 provides a user with the ability to select audio/video clips to use in a larger audio/video piece by selecting waveform images 230a, 230b, 230c, and 230d and then placing them in the preferred order, for instance, by dragging and dropping them on top of timeline 237. In this example, the user has dragged waveform images 201a, 201b, 201c, and 201d on top of timeline 237 such that waveform image 230d is the first clip, waveform image 201a is the second clip, waveform image 201b is the third clip, and waveform image 201c is the fourth clip. This, of course, is merely exemplary. The user could select from any number of audio/video clips and can place them the order of his or her choosing. These actions can occur on a computing device, such as mobile computing device 22, or another computing device such as computing device 28.

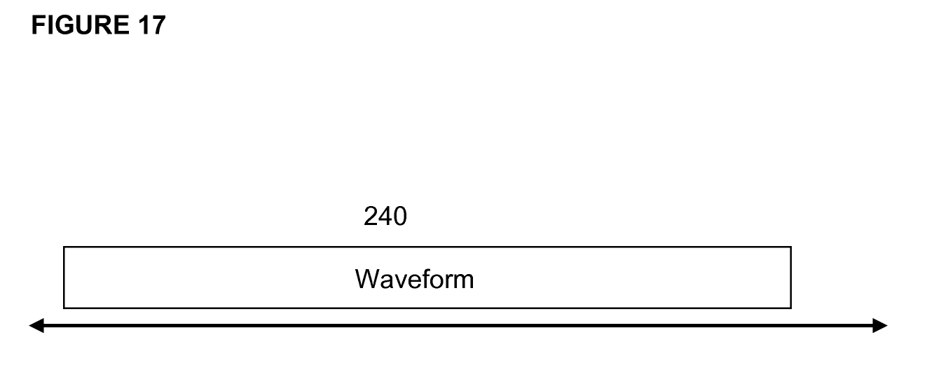

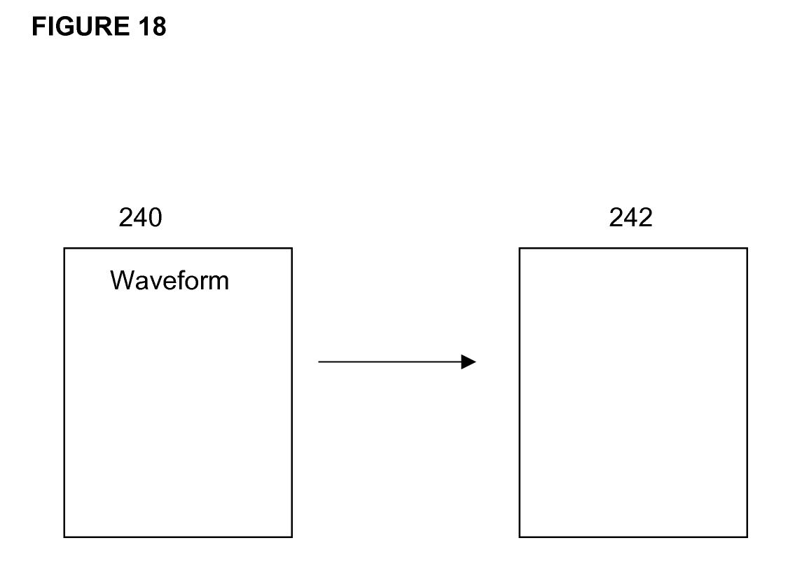

In FIG. 17, waveform images 230d, 230a, 230b, and 230c have been converted into a single waveform image 240. In FIG. 18, waveform image 240 is shown with its associated audio/video piece 242. Audio/video piece 242 will include the content from the underlying audio/video clips 201d, 201a, 201b, and 201c. For example, if those underlying audio/video clips were clips of music, then audio/video piece 242 will include each of those clips of music, which a user could listen to. Audio/video piece 242 optionally can include “transitions” between each underlying audio/video clips 201d, 201a, 201b, and 201c. For instance, in the audio realm, the transitions might include fading of one audio clip before a second audio clip begins, or the placement of “filler” audio data (such as a drum beat). In the video realm, the transitions might include fading of one video clip before a second audio clip begins, or a gradual morphing of one video clip into another. These actions can occur on a computing device, such as mobile computing device 22, or another computing device such as computing device 28. The transitions can be selected by the user or automatically by a computing device. The transitions also can comprise the insertion of other audio or video content, such as advertising, a photo, other audio or video clips, or a “laugh track” that is commonly used in TV sitcoms or advertising. In the realm of advertising, a computing device optionally can select advertising content based on the underlying audio/video content of audio/video clips 201a, 201b, 201c, and 201d. One example of such targeted advertising is described in commonly-owned and co-pending U.S. patent application Ser. No. 11/490,798, previously discussed and incorporated by reference. For example, if one audio clip contained the word “car” in it, then a computing device could insert an advertisement on cars as part of the transition between clips.

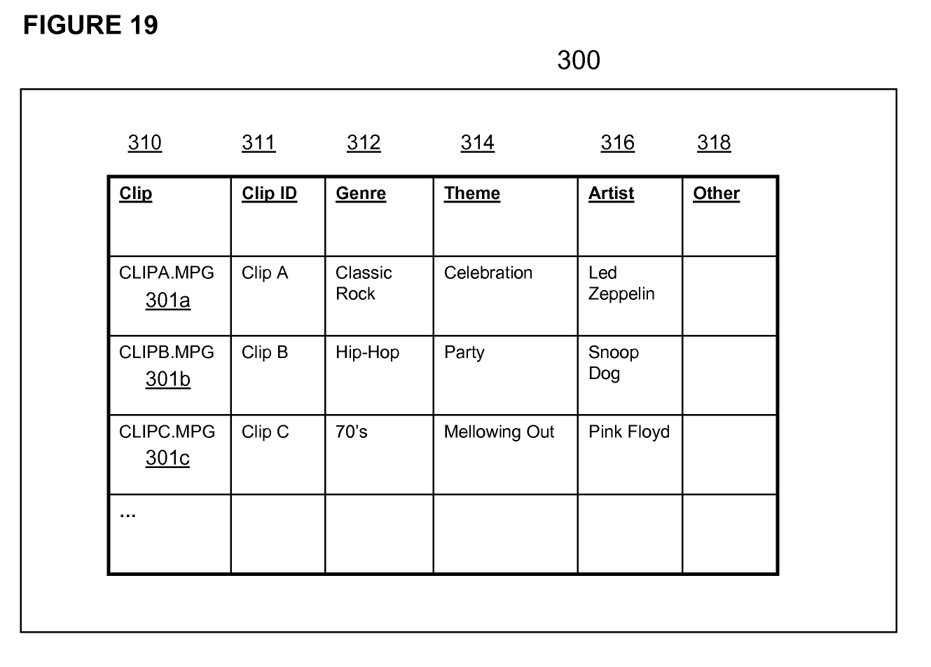

In another embodiment, with reference to FIG. 19, a database can be used to store audio/video clips and associated data. FIG. 19 shows exemplary database 300. Database 300 optionally can be an Oracle® database running on a computer server. The database can include fields for clip 310, clip ID 311, genre 312, theme 314, artist 316, and any other field 318. Clip 310 can be used to identify an audio/video clip previously created by a user (or created automatically by a computing device). Here, exemplary database includes entries for audio/video clips 301a, 301b, and 301c. Audio/video clips 301a, 301b, and 301c can be identified using a CLIP ID 311, which can be a unique identifier (such as a unique name or number assigned to the clip when it is first stored in database 300, or a number generated from the metadata or underlying data associated with the clip), the title of the song/video from which it was first created, or by any other identifier. Database 300 can include data in each of the other fields associated with each audio/video clip 301a, 301b, and 301c.

For example, the genre field 312 can include information about the genre of the underlying audio (e.g., Classic Rock) or of video (e.g., action movie) of the clip. These can be input by the user who created the chip, or can be imported from data associated with the audio/video content from which the clip was generated. Theme field 314 can be used to describe a scenario in which the clip may be appropriate to use. For example, if audio/video clip 301c (Clip C) has a very mellow feel to it, then an appropriate theme for it may be “mellowing out.” This theme can be chosen by the user who generated audio/video clip 301c (Clip C), or it can be automatically determined by a computing device (such as by analyzing the beat of the music or the words in the title of the audio/video content). It also can be determined by users when they choose audio/video clip 301c (Clip C) to be concatenated with other clips to create an audio/video piece. For example, if a user wants to create an audio/video piece with a mellow feel to it and chooses audio/video clip 301c (Clip C), then the user can identify audio/video clip 301c (Clip C) as being appropriate for a “mellowing out” theme, or in the alternative, a computing device could automatically determine that based on other actions taken by the user (for example, if the user sends the audio/video piece to a friend with a message that says, “John—this will help you mellow out!”). Artist field 316 can store the name of the artist who created the audio/video content. Other fields 318 can be added to describe additional information about the clip.

Database 300 optionally can be used as a searchable library in which a user can find and use audio/video clips in creating an audio/video piece. For example, if a user wants to create an audio/video piece about celebrations, then it can search within database 300 (using well-known search mechanisms) to look for audio/video clips that have a theme of “celebration” in the theme field 314 or other fields 318. Such a search may yield audio/video clip 301 a (Clip A), which the user may then elect to use in creating an audio/video piece. Database 300 also can be used to generate recommendations for a user. For example, if a user chooses an audio/video clip that has a certain theme, database 300 can be used to recommend other audio/video clips that have the same theme. Recommendations also can be generated based upon the artist, genre, or any other characteristic (including whether prior users had chosen particular audio/video clips to be used together). The recommendation also may indicate the part of a song or video that a user may like, based on his previous selections. For example, if the user's prior history indicates that he or she enjoys loud music with a fast bass line, the database can be used to find other music, and even a particular portion of the music, with the same characteristic if it was previously recorded in a database field. Such characteristics could be based on an automated analysis of the music (e.g., measuring periodic beats in a song) or on comments previously made by other users concerning that music.

Storing theme information and genre information can have other uses. For example, when creating transitions (discussed previously), a computer or a user could select a transition to match the theme or genre of the audio/video clips between which the transition takes place. For example, if the theme of the audio/video clips is “love,” then a transition could be chosen that uses heart shapes.

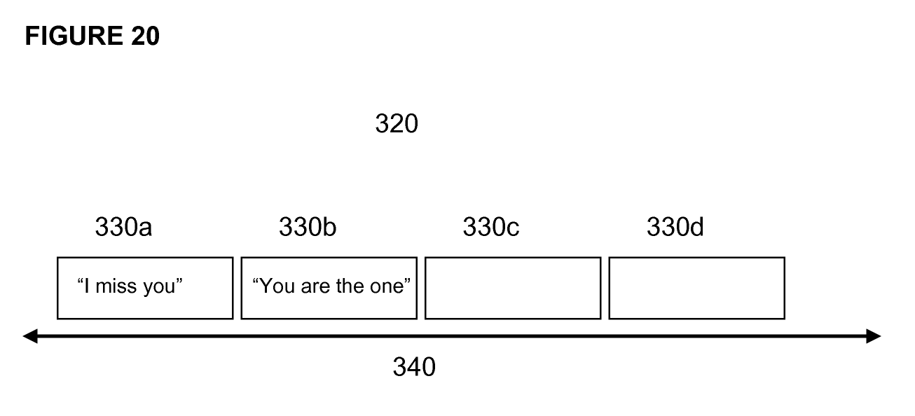

Another embodiment is shown in FIG. 20. Graphical user interface 320 is generated on a monitor, screen, or other visual device. Graphical user interface 320 provides a user with the ability to select audio/video clips to use in a larger audio/video piece by selecting audio/video clip representations 330a, 330b, 330c, and 330d and then placing them in the preferred order, for instance, by dragging and dropping them on top of timeline 340. Each audio/video clip representation 330a, 330b, 330c, and 330d has lyrics (in text form) associated with each clip. For example, a music clip can have an associated file containing the text of the lyrics contained in that clip. The lyrics optionally can be synchronized with the audio portion of the clip. Here, audio/video clip 330a is associated with the lyrics “I miss you” because those lyrics are contained the underlying audio clip. Similarly, audio/video clips 330b, 330c, and 330d can have associated text for the lyrics contained in each clip. These actions can occur on a computing device, such as mobile computing device 22, or another computing device such as computing device 28.

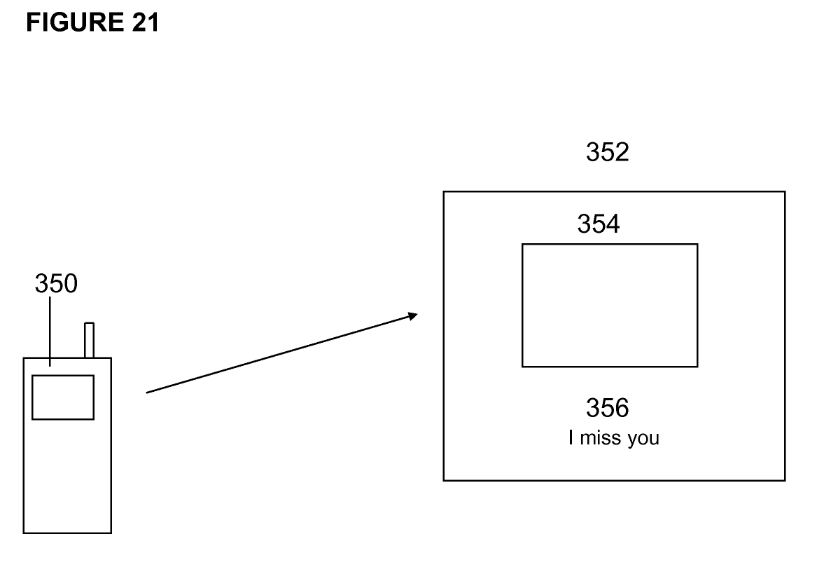

With reference now to FIG. 21, a mobile computing device 350 is shown, along with a larger image of its display device 352 (e.g., the screen on a mobile handset). When the user of mobile computing device 350 plays the audio/video piece created using the embodiment shown in FIG. 20, mobile computing device can play the underlying audio/video content and also can display the lyrics associated with that content. For example, in FIG. 21, the words “I miss you” are displayed in text window 356 on display device 352, along with the video portion 354 of the audio/video piece (such as video content, or if the piece consists purely of audio, then a photograph selected by the user who created the audio/video piece). Using this embodiment, the user of mobile computing device 350 can listen to audio and/or see video while also seeing the textual lyrics associated with that content. This allows one to user to create an audio/video piece whose lyrics or words tell a story or convey a message to another user who views or listens to the audio/video piece.

Any audio/video piece created by these embodiments can then be played for a user. It also can be used as a ringtone (on a mobile computing device, such as mobile computing device 22), disseminated over a social network (by a computing device such as mobile computing device 22, computing device 28, or another computing device), sold commercially using the mechanisms described previously, emailed, gifted to another user, traded with another user, posted on a web server or blog, or sent using any other communication mechanism.

Once created, audio/video pieces can be archived in a database or other storage mechanism. For example, a user can store his or her favorite audio pieces, optionally with comments, the theme of the piece, ratings, and other data.

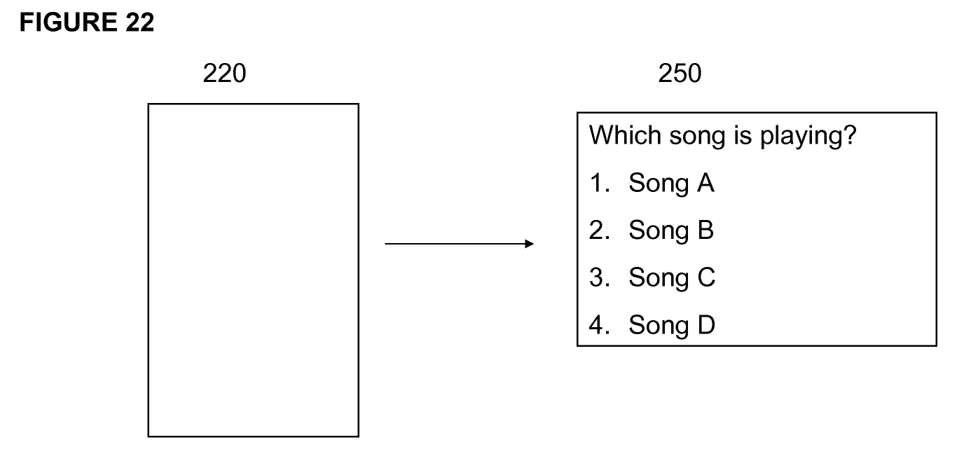

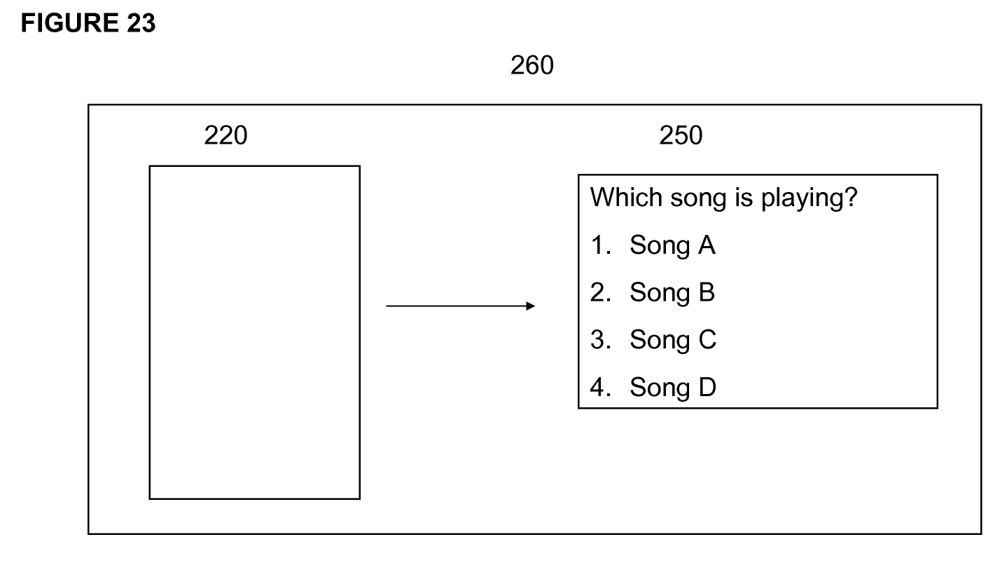

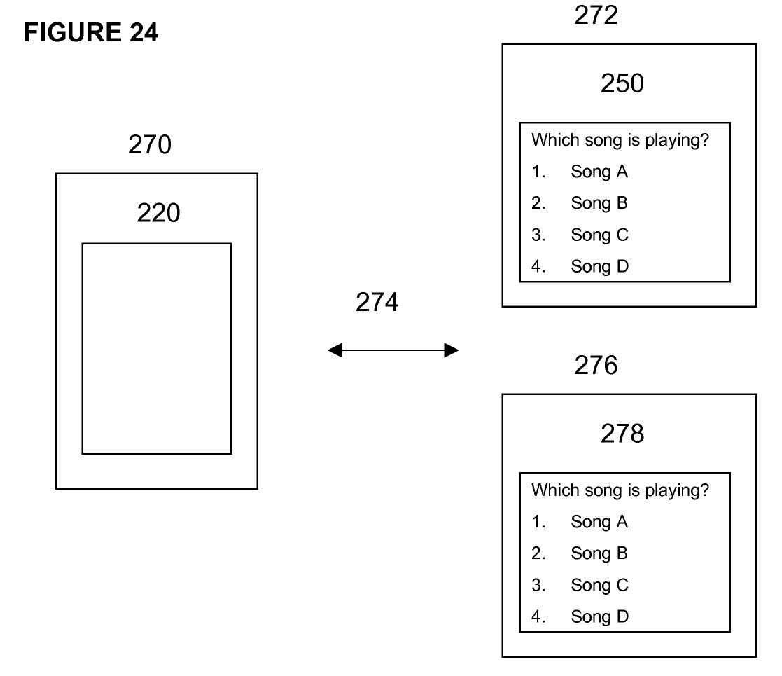

With reference to FIG. 22, in another embodiment, a computing device can provide an interactive game using audio/video piece 220. For example, if audio/video piece 220 comprises a plurality of music clips, a computing device can play audio/video piece and then ask a user to identify one or more of the underlying music clips. An exemplary user interface 250 is shown in FIG. 19, where a user is provided a multiple choice questionnaire to identify the music clip (which is a portion of audio/video piece 220) that currently is playing. A similar type of game can be created for video content (where, for example, a user is asked to identify a video clip that is playing, such as by selecting the name of a movie from a variety of choices). The user's selection can be compared to the correct answer (previously stored in a database or storage device), and the user can be provided a score at the end of the game. The user also could compete against other users over a network, with each user providing answers using a computing device connected to the network.

With reference now to FIG. 23, the interactive game optionally can occur on a local computing device 260 (such as a desktop computer, notebook computer, mobile handset, or other type of computing device), such that local computing device 260 stores audio/video piece 220 and presents user interface 250 to the user and operates the interactive game using a software application. In another example, with reference to FIG. 24, the interactive game can occur over a network 274, where, for example, a first computing device 270 performs certain actions for the game (such as storing audio/video piece 220 and/or checking a user's answers with the correct answers previously stored in a database or on a storage device), and a second computing device 272 is used to provide user interface 250 to a user, whereby the first computing device 270 and second computing device 272 are coupled over a network 274. Other users also can engage in the game, such as a user operating a third computing device 276 coupled to the first computing device 270 over network 274 (or over another network), and where the third computing device 276 provides user interface 278 to the user. User interface 278 and user interface 250 can be identical applications using the same data content or they can be different applications. Other players also can engage in the game by coupling to first computing device 270.

A multiple-player game such as the one described with reference to FIG. 24 can utilize audio/video pieces in other ways as well. For example, one game could award points to the user who is the first to guess the clip playing (e.g., guess the artist or title). Another game could involve a variation on bingo, where each player has a bingo card displayed on his or her user interface, and each space in the bingo card displays content associated with the underlying audio/video content of the audio/video pieces. For example, each space could display album cover art. When the user hears a song from that album playing, he or she can “mark” that space (and his or her computing device or the first computing device can check the accuracy of that mark).

Another game might involve revealing a portion of an image whenever a user makes a correct guess concerning an audio/video piece, which would simulate building a puzzle. Each time the user made a correct guess, a new “puzzle” piece could be added.

The games described above optionally could be played using individual audio/video clips instead of audio/video pieces.

Network 274 can comprise a LAN, 802.11 wireless network, cell phone network, CDMA network, WCDMA network, EDGE network, GSM network, GPRS network, 3G network, or other hard-wired or wireless network. First computing 270 also can be coupled to other computing devices (not shown) over network 274 or other networks, such that a plurality of users can compete in the same interactive game using a plurality of computing devices coupled to first computing device 270.

While the foregoing has been with reference to particular embodiments of the invention, it will be appreciated by those skilled in the art that changes in these embodiments may be made without departing from the principles and spirit of the invention, the scope of which is defined by the appended claims.

1. A method for creating and utilizing concatenated content clips, comprising:
creating a plurality of content clips using a mobile computing device;
selecting a plurality of said content clips using said mobile computing device;
selecting the order of said plurality of audio/video clips using said mobile computing device;
concatenating said plurality of audio/video clips in said order into a content piece;
playing said content piece on said mobile computing device.

2. The method of claim 1, further comprising disseminating said content piece over a social network.

3. The method of claim 1, wherein each content clip is an audio clip.

4. The method of claim 1, wherein each content clip is a video clip.

5. The method of claim 1, wherein said concatenating step is performed by a server.

6. The method of claim 1, wherein said concatenating step is performed by said mobile computing device.

7. The method of claim 1, further comprising comparing information received from a user with information associated with said content piece or one or more of said audio/video clips.

8. A method for creating and utilizing concatenated audio/video clips, comprising:
creating a plurality of audio/video clips using a mobile computing device;
selecting a plurality of said audio/video clips and determining the order of the audio/video clips using said mobile computing device,
concatenating said plurality of said audio/video clips into an audio/video piece;
using said audio/video piece as a ringer on said mobile computing device.

9. The method of claim 8, further comprising disseminating said audio/video piece over a social network.

10. The method of claim 8, wherein said plurality of audio/video clips are audio clips.

11. The method of claim 8, wherein said concatenating step is performed by a server.

12. The method of claim 8, wherein said concatenating step is performed by said mobile computing device

13. A system for creating and utilizing concatenated content clips, comprising:
a first computing device programmed to enable a user to create a plurality of content clips and to select a plurality of said content clips and to select the order of said content clips, wherein said first computing device is a mobile computing device;
a second computing device programmed to concatenate said plurality of audio/video clips in said order into a content piece;
said first computing device further programmed to play said content piece.

14. The system of claim 13, wherein one or more of said first computing device and said second computing device are programmed to disseminate said content piece over a social network.

15. The system of claim 13, wherein each content clip is an audio clip.

16. The system of claim 13, wherein each content clip is a video clip.

17. The system of claim 13, wherein said second computing device is a server.

18. The system of claim 13, wherein said second computing device is further programmed to compare information received over a network with information associated with said content piece or one or more of said audio/video clips.

19. A system for creating and utilizing concatenated audio/video clips, comprising:
a first computing device programmed to enable a user to create a plurality of audio/video clips and to select a plurality of said audio/video clips and to select the order of said audio/video clips, wherein said first computing device is a mobile computing device;
a second computing device programmed to concatenate said plurality of audio/video clips in said order into an audio/video piece;
said first computing device further programmed to use said audio/video piece as a ringer on said first computing device.

20. The system of claim 19, wherein one or more of said first computing device and said second computing device are programmed to disseminate said audio/video piece over a social network.

21. The system of claim 19, wherein said plurality of audio/video clips are audio clips.

22. The system of claim 19, wherein said second computing device is a server.

23. The system of claim 19, wherein said second computing device is further programmed to compare information received over a network with information associated with said content piece or one or more of said audio/video clips.
